(19) United States
(12) Patent Application Publication
(10) Pub. No.: US 2011/0209667 A1
(43) Pub. Date: Sep. 1, 2011

(54) Storage Apparatus for Aquatic Animals

(76) Inventors: Jacqueline Rachel Day, Nelson (NZ); Alistair Renfrew Jerrett, Nelson (NZ)

(21) Appl. No.: 13/101,375

(22) Filed: May 5, 2011

Related U.S. Application Data
(63) Continuation of application No. 10/582,550, filed on Oct. 6, 2008.

(30) Foreign Application Priority Data
Dec. 9, 2003 (NZ) 530048

(51) Int. Cl. A01K 63/02; A01K 63/04

(52) U.S. Cl. 119/201; 119/263

(57) ABSTRACT

An apparatus for storing aquatic animals comprises a tank for receipt of the aquatic animals, and an arrangement to create a foam environment in the interior of the tank such that at least a majority of the aquatic animals when stored in the tank are submerged in foam. The arrangement to create a foam environment may be configured to deliver a synthetic foam to the interior of the tank, or may be configured to generate the foam, preferably from the natural proteins of the aquatic animals. A fluid recirculation arrangement may recirculate fluid to generate the foam.

### FIELD OF THE INVENTION

This invention relates to apparatus for storing or preserving aquatic animals. While the invention is described with reference to shellfish, it will have application for storing other aquatic animals.

### BACKGROUND

Shellfish such as mussels, oysters, and the like are considered to be a delicacy, and warrant high prices, particularly in overseas markets. In order to ensure satisfaction, it is important that the shellfish remain alive, fresh and undamaged until use.

The applicant is aware of three existing types of systems for storing shellfish. The first is a dry storage system, in which the shellfish are placed in woven plastic bales and stored without any additional fluid added to the bales.

The second is a submerged system, in which the shellfish are fully submerged in a liquid (generally seawater) throughout the duration of storage.

The third is the spray arrangement typically used in supermarkets, in which water is sprayed over the shellfish to keep them moist.

It has been found that the existing storage systems can adversely affect the quality of the shellfish, and throughout the duration of storage, the shellfish may show reductions in weight and eating quality.

An object of at least preferred embodiments of the present invention is to provide an apparatus and method for storing aquatic animals which addresses at least one of the problems outlined above and/or which at least provides the public with a useful choice.

### SUMMARY OF THE INVENTION

In accordance with a first aspect of the present invention, there is provided an apparatus for storing aquatic animals, comprising a tank for receipt of the aquatic animals, and an arrangement to create a foam environment in the interior of the tank and configured such that at least a majority of the aquatic animals when stored in the tank are submerged in foam.

The term ‘comprising’ as used in this specification and claims means ‘consisting at least in part of’, that is to say when interpreting independent claims including that term, the features prefaced by that term in each claim all need to be present but other features can also be present.

As used herein, “foam” should be considered to mean a suspension of gas bubbles in a liquid.

As used herein, “storing” or “storage” could occur on a harvesting vessel or in an environment such as a factory for example, or could occur during transport of live aquatic animals. It may or may not be long term storage.

The aquatic animals are preferably shellfish such as mussels, but other shellfish may be stored using such an apparatus or method, such as oysters, scallops, clams or abalone. Further, the aquatic animals could be crustaceans or eels for example.

The apparatus is preferably used to store a single species of aquatic animal.

The arrangement to create a foam environment in the interior of the tank is preferably configured to deliver a foam to the interior of the tank. Preferably, the arrangement to create a foam environment in the interior of the tank comprises a device, such as one or more spray nozzles for example, configured to apply foam over at least a majority of the aquatic animals when stored in the tank.

Preferably, the arrangement to create a foam environment in the interior of the tank is configured to deliver a synthetic foam to the interior of the tank. The foam may be one which has been specifically formulated for such an application to obtain or maintain the desired quality of the aquatic animals.

Alternatively or in addition, the arrangement to create a foam environment in the interior of the tank is preferably configured to generate foam. The arrangement to create a foam environment in the interior of the tank preferably comprises a fluid recirculation arrangement which is configured to recirculate fluid from a lower region of the interior of the tank in which the aquatic animals are to be stored to a higher region of the interior of the tank, such that the fluid passes over at least a majority of the aquatic animals when stored in the tank and the natural proteins of the aquatic animals create a foam as the fluid is recirculated.

The arrangement to create a foam environment may additionally be to introduce one or more property-enhancing substances into the fluid or foam such as sanitising agents or the like.

The arrangement to create a foam environment in the interior of the tank is preferably configured to introduce pressurised gas into the fluid to enhance foam generation. In a preferred embodiment, the arrangement to create a foam environment in the interior of the tank comprises a fluid pathway extending from a lower region of the tank to a higher region of the tank, and additionally comprises an arrangement to introduce pressurised gas into the fluid pathway which generates a vacuum to suck fluid from the lower region of the tank and deliver fluid to the higher region of the tank via the fluid pathway, to apply the fluid as a foam over at least a majority of the aquatic animals when stored in the tank. The apparatus is preferably configured to introduce the pressurised gas in pulses, so that the foam is applied over the aquatic animals in pulses. The pulses may be spaced by 1-2 seconds for example, or could be more intermittent such as every 10-20 seconds which may be sufficient for some applications.

Preferably, the gas is refrigerated or humidified.

The apparatus may be configured to introduce at least one property-enhancing substance with the gas.

The gas is preferably air.

In accordance with a second aspect of the present invention, there is provided an apparatus for storing aquatic animals, comprising a tank for receipt of the aquatic animals, and a fluid recirculation arrangement which is configured to recirculate fluid from a lower region of the interior of the tank in which the aquatic animals are stored to a higher region of the interior of the tank, such that the fluid passes over at least a majority of the aquatic animals when stored in the tank and the natural proteins of the aquatic animals create a foam as the fluid is recirculated, such that at least a majority of the aquatic animals when stored in the tank are submerged in foam.

In accordance with a third aspect of the present invention, there is provided a method of storing aquatic animals, comprising providing an apparatus as outlined in the first aspect above, loading the aquatic animals into the interior of the tank, and creating a foam environment in the interior of the tank such that at least a majority of the aquatic animals in the tank are submerged in foam.

The method could be used to hold aquatic animals on a harvesting vessel or in an environment such as a factory for example, or could be used for the transport of live aquatic animals. It may or may not be long term storage.

The apparatus may have any of the features outlined in respect of the first or second aspects above.

The method preferably comprises packing the aquatic animals relatively tightly in the interior of the tank to form a packed bed, so that the foam moves slowly around the aquatic animals in the tank.

The method preferably comprises using the apparatus to generate foam from the natural proteins of the aquatic animals. In a preferred embodiment, the method comprises recirculating fluid from a lower region of the interior of the tank to a higher region of the interior of the tank and over at least a majority of the aquatic animals in the tank to generate foam from the natural proteins of the aquatic animals.

The method may comprise mixing pressurised gas with the fluid to enhance foam generation. That may be particularly useful in summer months, as the relatively warm temperature of the gas may result in stripping of tainting compounds or toxins from the aquatic animals. The method preferably comprises introducing the pressurised gas in pulses, so that the foam is recirculated back into the higher region of the tank and over the aquatic animals in pulses.

The gas may be refrigerated or humidified.

The method preferably comprises introducing at least one property-enhancing substance with the gas.

The gas is preferably air.

The aquatic animals are preferably shellfish such as mussels, but other shellfish may be stored or transported using such an apparatus or method, such as oysters, scallops, clams or abalone. Further, the aquatic animals could be crustaceans or eels for example.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

The invention will be described by way of example only and with reference to the accompanying drawings in which:

FIG. 1 is a schematic view of a preferred embodiment apparatus for storing shellfish;

FIG. 2 is a schematic view of a preferred embodiment arrangement to create a foam environment in the interior of the tank, from the apparatus of FIG. 1; and

FIG. 3 shows a preferred embodiment apparatus similar to that of FIG. 1 being used to store mussels.

### DETAILED DESCRIPTION OF PREFERRED FORMS

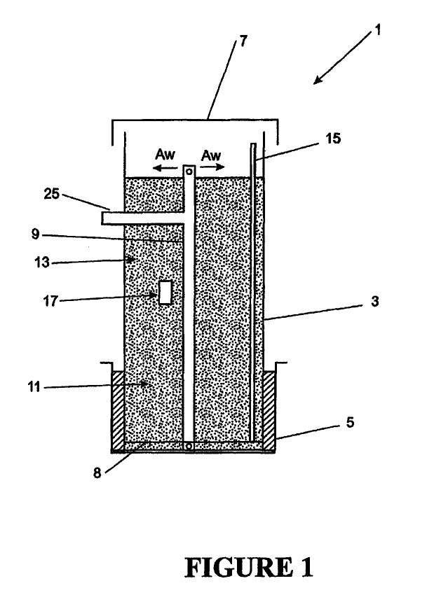

With reference to FIG. 1, the preferred apparatus is indicated generally by reference numeral 1 and includes a main tank 3. As used herein, “tank” should be considered to mean any type of housing suitable for holding aquatic animals. The tank may be made of plastic, glass, metal or other suitable material. In the form shown, the tank comprises a plastic tube, the base of which is placed in a rigid bin 5 to provide support. However, it will be appreciated that in commercial embodiments, the tank may be made of a more rigid material, and may not include the base bin 5.

The interior of the tank 3 is configured to receive aquatic animals such as shellfish for storage, and has a removable cover 7 to help minimise the number of contaminants entering the tank. The apparatus includes a preferred arrangement 9 to create a foam environment in the interior of the tank, which in this embodiment is configured to generate foam. The purpose of the arrangement 9 is to create a foam environment in the interior of the tank, so that at least a majority of the aquatic animals are submerged in foam represented by reference numeral 13. The apparatus shown in the figures is configured for experimental purposes, and for that reason includes a sample tube 15 and a data logger 17.

The bin 5 is shown as containing seawater 11, which helps regulate the storage temperatures in the tube.

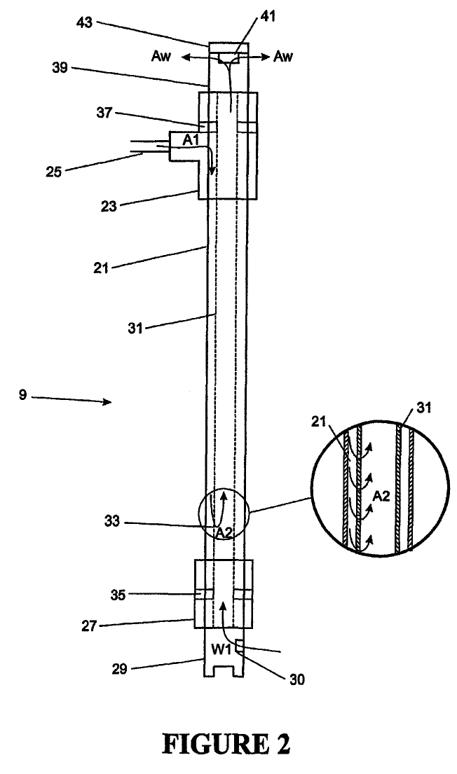

With reference to FIG. 2, the preferred arrangement 9 to create a foam environment comprises a recirculation system and includes an outer tube 21, the upper end of which is coupled to a T-joint 23. Extending into the side of the T-joint (and through the wall of the tank as shown in FIG. 1) is a gas supply tube 25. Pressurised gas, such as air or another gas if desired, is delivered into the coupling and outer tube via the gas supply tube 25. The lower end of the outer tube 21 is connected to a coupling 27, which in turn is connected to a lower coupling 29 which is configured to sit on the base of the tank. The lower coupling is in fluid communication with the tank via one or more apertures 30.

Extending through the coupling 27 and the outer tube 21 and into the T-joint 23 is an inner tube 31. The interior of the lower coupling 29 is in fluid communication with the interior of the tank and the interior of the inner tube 31. The interior of the outer tube 21 is in gas communication with the interior of the inner tube 31 via a plurality of apertures 33 in the inner tube 31 (see inset to FIG. 2). The interior of the inner tube is sealed off from the interior of the coupling 29 (other than through the inner tube 31) by a seal in the form of an O-ring 35.

The gas supply tube 25 is sealed off from the upper part of the T-joint 23 by a seal in the form of an O-ring 37. The upper end of the T-joint is attached to a coupling 39 which has one or more apertures 41 at its upper end, and the upper end of which is closed off by a cover 43.

Reverting to FIG. 1, an optional screen 8 is positioned across the interior of the tank and spaced from the base of the tank. This will be positioned above the aperture(s) 30 in the lower coupling 29, and serves to provide additional filtration to prevent large debris blocking the recirculation system. Other filters can be provided in parts of the system as required.

The operation of the apparatus is as follows. Aquatic animals are loaded into the interior 13 of tank 3, and the tank is partly filled with fluid which is generally seawater, but which may be a different type of fluid. The removable lid is then positioned on the top of the tank to reduce contaminants. Pressurised gas is delivered into the arrangement 9 through the gas supply tube 25. Due to the seal 37 and generally solid inner tube 31, the gas travels downwardly within outer tube 21 as indicated by arrow A₁. Once it reaches the lower end of the tube 21, it is directed upwardly by the lower O-ring 35 and into the inner tube through the apertures as indicated by arrow A₂. As the interior of the inner tube 31 is in fluid communication with the interior of the tank via the aperture(s) 30 in the coupling 29, the upward travel of gas in the inner tube creates a vacuum in the inner tube, which sucks fluid from the tank in through the coupling 29 and directs it upwardly through the inner tube 31.

The fluid is mixed with the gas within the inner tube, which enhances foam generation. The gas drives the foam up through the inner tube 31 and out through the aperture(s) 41 in the coupling 39 above the T-joint 23 in a path indicated by arrow A_{w}. The foam is applied over the shellfish, and will trickle down over the shellfish under the influence of gravity, to ultimately be extracted into the coupling 29 again. Over time, the amount of liquid seawater will reduce and the amount of fluidised foam will increase, due to the mixing of the seawater with gas and shellfish proteins.

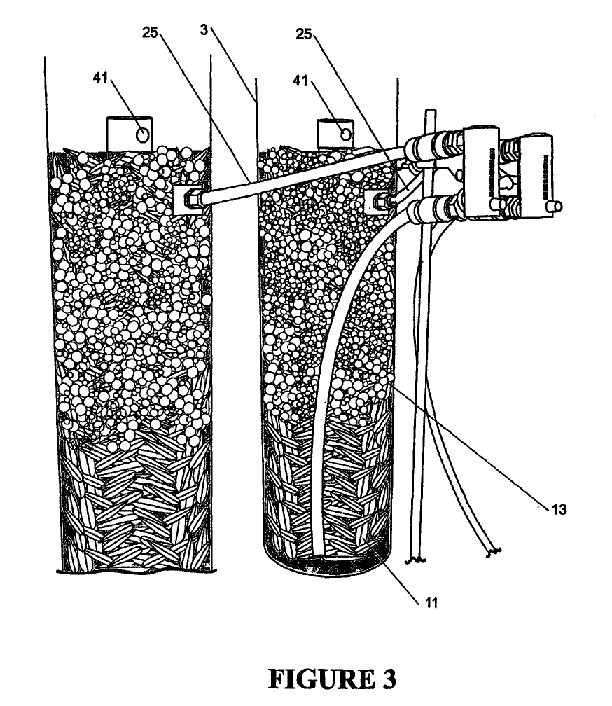

FIG. 3 shows the preferred embodiment apparatus in use. It can be seen that the shellfish in the lower part of the tank 3 are sitting primarily in seawater, whereas the shellfish in about the top three quarters of the tank are sitting primarily in foam. While the invention is concerned with generating a foam environment for the shellfish, it will be appreciated that some of the shellfish can be stored in another fluid such as seawater, and such a configuration is still within the scope of this invention. The relative proportions of foam and seawater can be varied by reducing the amount of seawater initially delivered into the tank, or by increasing the gas flow to a certain extent through the arrangement 9. As outlined above, over time the amount of foam will generally increase and the amount of seawater will generally reduce.

It will be appreciated that the particular components making up the foam generating arrangement can be varied, while still functioning in the same manner. The advantages of the preferred embodiment apparatus will be apparent from the experimental data below.

### EXPERIMENTS

### Experimental Shellfish

### Experiments 1 and 2

A sample of mussels (approx. 120 kg) was collected from a factory bale store (i.e. where mussels are stored in approx. 1 tonne bales) and transported to the laboratory. On arrival at the laboratory the sample was mixed and evenly distributed between five 200 L plastic tanks. The tanks were supplied with unfiltered seawater on a flow-through basis at a rate of 50 Mussels were left undisturbed for 24 hours.

### Experiments 3 and 4

Pre-harvest mussels (still attached to the growout ropes) and post-harvest mussels (mussels that had been through the full mechanical harvesting process) were obtained. They were collected on board a mussel harvesting barge, and placed into a 750 L bin supplied with fresh seawater on a flow-through basis at a rate of 100 L/min. On arrival, the water supply was shut off and the bin was transferred to a vehicle. An air compressor supplied air to the bin of mussels via two airstones for the journey back to the laboratory (approx 3 hours).

On arrival at the laboratory the post-harvest mussels were transferred to 200 L plastic bins supplied with unfiltered seawater on a flow-through basis at a rate of 50 L/min. The pre-harvest mussels still on the growout ropes were hung in a 4 m tank supplied with unfiltered seawater on a flow-through basis at a rate of 50 L/min. Mussels were left undisturbed for 14 to 18 hours prior to experimentation.

Prior to experimentation, the pre-harvest mussels were manually removed from the growout ropes. Therefore, for Experiment 4 for example, it will be appreciated that the terminology “pre-harvest” refers to mussels collected as described above and then manually removed from the growout ropes prior to the experiment.

Storage Treatments

Three storage conditions were investigated: a prior art dry storage system (Experiments 1 to 4); a prior art submerged system (Experiment 1 only); and the preferred embodiment apparatus (Experiments 1 to 4). Storage of the mussels in all three treatments used a 300 mm diameter, 1 m high tube, closed at one end that was constructed from 1 mm transparent forming plastic sheet. The tubes enabled stacking of the mussels in the tube to a height similar to that of the half tonne bales normally used after grading post harvest mussels. The transparent nature of the plastic tubes also allowed for monitoring of the mussel filtering behaviour during storage simulations.

Each tube full of mussels was placed inside a 75 L plastic bin. The plastic bins containing the preferred foam generating apparatus and submerged storage tubes were filled with seawater to help regulate the storage temperatures. The plastic bin containing the dry storage tube was used to collect any excess water that was draining out of sixty×2 mm holes in the bottom of the tube (only the dry storage tube had these holes). Temperature loggers (Hobo data loggers, product number H08-002-02) were placed in the middle of each tube.

Three samples of forty five mussels were placed at the top, middle and bottom of each storage tube. Each sample was made up of three mesh bags filled with fifteen mussels in each. All the mussels were individually weighed and the length and width recorded before being placed in the onion bag. This enabled identification of each mussel after storage so the weight of the mussels could be followed over the entire storage trial. The rest of the tube was filled with mussels from the appropriate sample (either from the bale store or pre- or post-harvest mussels from the harvesting barge). The preferred embodiment apparatus set-up differed to the other storage treatments in that the foam generating arrangement was placed down the middle of the plastic tube, positioned so that the air hose 25 could be attached through the hole in the side of the tube (FIG. 1).

A water sampling pipe (20 mm PVC pipe containing Nylon tubing (¼″ OD)) was also placed in the plastic tube with the air lift apparatus (described below). Samples, mussels and data logger were then positioned in the same manner as for the dry and the submerged arrangements.

Preferred Embodiment Apparatus

The preferred embodiment apparatus utilizes an overdriven air lift that creates a foam which, in turn, creates a fluidized foam bed that the mussels are held in. The air/water interface provided by the foam also allows good gas exchange to enable the mussels to respire throughout storage. The air lift was predominantly made from PVC fittings (FIG. 2). The preferred model stands at 833 mm high and consists of an internal 20 mm PVC pipe 31 that is 750 mm long. This has twenty four×1 mm holes drilled in three rings 33, 9-11 cm up from the bottom. Surrounding this is the external pipe (25 mm PVC) 21 that is 950 mm long. The base coupling is a 20 mm coupling 29 with four 12×16 mm slots machined into it. These slots allow fluid (generally water) to be drawn up the inner tube 31 from the tank. An O-ring 35 is provided in the coupling 27.

At the top of the air lift arrangement the pipes join into a 25 mm T-joint 23. The 20 mm (internal) pipe 31 is inserted two thirds of the way up where it is held in place by an O-ring 37. The 25 min (external) pipe 21 slots in approximately one third of the way. This allows the air or other gas coming into the T-joint 23 to go down between the pipes and then be forced through the 1 mm holes into the internal pipe and then bring water back up to be forced out the top of the air lift. This air comes out of the T-joint 23 where there is an O-ring 37 and a 20 mm coupler 39 that has had eight 10×5 mm slots 41 machined out of it. The coupler has a 6 mm deep plastic disk 43 that is glued on the top of the machined slots to force the air (or gas) and water out of the air lift substantially horizontally.

### Post-Storage Measurements

After a given storage time (twenty five to forty eight hours) a sample of mussels from the top, middle and bottom of the storage tubes was removed from each storage treatment and the individual mussels weighed.

Once each mussel was weighed they were placed posterior down in cooking racks to keep each storage treatment separate and allow for the individual tracking of the mussels through the cooking process. Mussels were then blanched for four minutes at 85° C. in a 135 L stainless steel stirred water bath filled with freshwater.

After the blanching step the mussel rack was removed from the water bath and placed inside a 20 L plastic bin that was surrounded by ice on the outside for a further 4 minutes for cooling. After cooling each mussel was individually shucked and the meat weights recorded. A sample of mussels (50) from both the pre- and post-harvest groups that had not been used in the storage trials were also weighed and blanched to give a zero time comparison to the storage treatments.

Results

Four experiments were carried out to evaluate the performance of the preferred embodiment apparatus.

The first two experiments were performed on mussels that had been collected from the bale store and the final two on mussels that had been brought to laboratories under controlled conditions. For each experiment the data collected from mussels sampled from the top, middle and bottom of each storage treatment were combined.

### Mussels Sampled from the Bale Store and Stored Dry, Submerged or in the Preferred Embodiment Apparatus

### Experiment 1

The change in whole mussel weight after twenty five hours storage is shown in Table 1. Mussels stored dry lost the most weight out of the three storage treatments followed by submerged mussels. Mussels stored in the preferred embodiment apparatus lost only 2% of their initial weight.

TABLE 1
Whole weight change in mussels from the bale store stored under
three different conditions for 25 hours (Experiment 1)

| | | | Preferred |
|---|---|---|---|
| | Dry | Submerged | Embodiment |
| Pre-storage wgt (g) | 51.6 ± 0.7 | 51.2 ± 0.7 | 51.2 ± 0.6 |
| | (n = 128) | (n = 131) | (n = 114) |
| Post-storage wgt (g) | 48.2 ± 0.8 | 49.2 ± 0.7 | 50.1 ± 0.6 |
| % wgt loss | 6.6* | 3.9*† | 2.1 |

Values are the mean ± SEM (standard error of the mean).
*Significantly different from the sample from the preferred embodiment apparatus (P < 0.05)
†Significantly different (P < 0.05) from sample from the preferred embodiment apparatus, but not the dry sample

Storage of mussels in the preferred embodiment apparatus resulted in the highest blanched meat weight (Table 2). The conditions provided by the preferred embodiment apparatus produced an average increase in blanched meat weight of 0.8 g over the current commercial dry storage treatment. The results for post blanching meat weight were significantly different between the dry and preferred embodiment apparatus samples but this was not so between the dry and the submerged.

TABLE 2
Performance of mussels from the bale store stored under
three different conditions for 25 hours (Experiment 1)

| | | | | Preferred |
|---|---|---|---|---|
| Results | ZeroTime | Dry | Submerged | Embodiment |
| Meat weight (g) | 14.0 ± 0.2 | 14.0 ± 0.2* | 13.9 ± 0.2† | 14.8 ± 0.2 |

Values are the mean ± SEM (standard error of the mean).
*Significantly different (P < 0.05) from the sample from the preferred embodiment apparatus
†Significantly different (P < 0.05) from sample from the preferred embodiment apparatus, but not dry sample

It was noted when setting these samples up for recovery that ˜30% of the sample obtained from the bale store was damaged or moribund. At the start of the experiment it was noted that after the submerged samples had been weighed, and placed in the cooking racks prior to blanching they were unable to hold onto their intravalvular water.

They were opening ≧1 mm while in the racks and then a large amount of intravalvular water was draining out. During the shucking it was noted that the mussels stored in the preferred embodiment apparatus were fresh smelling (seawater smell) and easy to shuck. Mussels stored dry, smelled slightly off and musty whereas the submerged system had a very strong sulphur smell.

### Mussels Sampled from the Bale Store and Stored Dry or in the Preferred Embodiment Apparatus

### Experiment 2

To confirm the results of Experiment 1 the storage trial was repeated using another batch of mussels collected from the bale store, and set up the same as the first experiment but without the submerged storage treatment. The storage time was also increased to forty five hours.

The change in whole mussel weight after forty five hours storage is shown in Table 3. Mussels stored dry lost more weight than mussels stored in the preferred embodiment apparatus which lost only 3.6% of their initial weight.

TABLE 3
Whole weight change in mussels from the bale store
stored under dry conditions or in the preferred
embodiments for 45 hours (Experiment 2)

| | Dry | Preferred Embodiment |
|---|---|---|
| Pre-storage wgt (g) | 56.1 ± 0. | 56.2 ± 0.7 |
| | (n = 82) | (n = 109) |
| Post-storage wgt (g) | 46.4 ± 0.8 | 54.2 ± 0.8 |
| % wgt loss | 17.3* | 3.6 |

Values are the mean ± SEM (standard error of the mean).
*Significantly different from the sample from the preferred embodiment system (P < 0.05)

Post-blanching meat weight was again found to be highest in the mussels from the preferred embodiment apparatus, but this was not significantly different from the dry storage mussels.

TABLE 4
Performance of mussels from the bale store stored
under dry conditions or in the preferred embodiment
apparatus for 45 hours (Experiment 2)

| | | | Preferred |
|---|---|---|---|
| Results | Zero Time | Dry | Embodiment |
| Meat weight (g) | 13.8 ± 0.3 | 14.5 ± 0.3* | 15.0 ± 0.2 |

Values are the mean ± SEM (standard error of the mean).
*Not significantly different to the sample from the preferred embodiment apparatus

While shucking it was noted that the cooked mussel meats from dry storage were in poor condition, were dry and had degenerative tears between the lips and the meat near the foot. The sample taken from the top of the dry storage tube had an unpleasant odour characteristic of petrification. In comparison, mussels sampled from the preferred embodiment apparatus were in better condition, more moist and had fewer degenerative tears. Incidence of lip adhesion and mortality during live storage was much lower in the preferred embodiment storage treatment.

### Mussels Sampled Onboard the Harvesting Barge—Post-Harvest Mussels Stored Dry or in the Preferred Embodiment Apparatus

### Experiment 3

From the results in the first two experiments it became apparent that the condition of mussels sampled from the bale store (˜30% were damaged or moribund before set up) may have had an effect on the results. To try and minimise the deterioration of condition due to transport of the mussels from the harvesting barge to the mussel processing factory and then storage of the mussels in the bale store (could be up to twenty four hours after the initial harvest) the mussels used in Experiments 3 and 4 were collected directly from the harvesting barge and transported back to the laboratory submerged in aerated seawater (about three hours).

The change in whole mussel weight of post-harvest mussels after forty eight hours storage is shown in Table 5. Mussels stored dry lost significantly more weight than mussels stored in the preferred embodiment apparatus. Post-blanching meat weight was significantly higher in the preferred embodiment apparatus.

TABLE 5
Whole weight changes of post-harvest mussels stored dry or in
the preferred embodiment apparatus for 48 hours (Experiment 3)

| | Dry | Preferred Embodiment |
|---|---|---|
| Pre-storage wgt (g) | 47.8 ± 0.8 | 48.5 ± 0.9 |
| | (n = 128) | (n = 133) |
| Post-storage wgt (g) | 39.0 ± 0.8 | 46.6 ± 0.9 |
| % weight loss | 18.4* | 3.9 |

Values are the mean ± SEM (standard error of the mean).
*Significantly different from the sample from the preferred embodiment apparatus (P < 0.05)

TABLE 6
Performance of post-harvest mussels stored dry or in the preferred
embodiment apparatus for 48 hours (Experiment 3)

| | | | Preferred |
|---|---|---|---|
| Results | Zero Time | Dry | Embodiment |
| Meat weight (g) | 11.0 ± 0.3 | 10.6 ± 0.3* | 11.9 ± 0.3 |
| | (n = 50) | (n = 128) | (n = 133) |

Values are the mean ± SEM (standard error of the mean).
*Significantly different from the sample from the preferred embodiment apparatus (P < 0.05)

During shucking it was noted that mussels stored in the preferred embodiment apparatus appeared to be more moist, easier to shuck and smelt fresher than the dry stored mussels.

### Mussels Sampled Onboard the Harvesting Barge: Pre- and Post-Harvest Mussels Stored Dry or in the Preferred Embodiment Apparatus

### Experiment 4

Experiment 4 was a repeat of Experiment 3 with both pre- and post-harvest mussels.

The change in whole mussel weight of both pre- and post-harvest mussels after forty five hours storage is shown in Table 7. Again, mussels stored dry lost significantly more weight than mussels stored in the preferred embodiment apparatus. When pre and post harvest mussels were stored dry, the pre-harvest mussels lost significantly more weight than the post harvest animals. In the preferred embodiment apparatus there was no difference between the two groups of mussels (Table 7).

TABLE 7
Whole weight changes of pre-and post-harvest mussels
stored dry or in the preferred embodiment apparatus
for forty four hours (Experiment 4)

| | Dry | | Preferred Embodiment | |
|---|---|---|---|---|
| | Pre | Post | Pre | Post |
| Pre-storage wgt (g) | 56.3 ± 0.8 | 55.7 ± 0.8 | 56.1 ± 0.8 | 56.6 ± 0.9 |
| | (n = 135) | (n = 136) | (n = 134) | (n = 134) |
| Post-storage wgt (g) | 49.7 ± 0.8 | 50.8 ± 0.9 | 55.4 ± 0.8 | 55.1 ± 0.9 |
| % wgt loss | 11.7† | 8.8‡ | 1.2 | 2.7 |

Values are the mean ± SEM (standard error of the mean).
†Significantly different from the sample from the preferred embodiment apparatus (P < 0.05)
‡Significantly different from the sample from the preferred embodiment apparatus (P < 0.05)

After forty four hours storage the blanched meat weight of dry stored mussels was not different to the mussels sampled at zero time (Table 8). However, the meat weight of mussels stored in the preferred embodiment apparatus was significantly higher than the dry mussels (Table 8) and also significantly higher than mussels sampled at zero time.

TABLE 8
Performance of pre-and post-harvest mussels stored dry or
in the preferred embodiment apparatus for 44 hours (Experiment 4)

| | | | | | Preferred | |
|---|---|---|---|---|---|---|
| | Zero Time | | Dry | | Embodiment | |
| | Pre | Post | Pre | Post | Pre | Post |
| Meat | 11.5 ± | 12.7 ± | 11.6 ± | 11.9 ± | 14.0 ± | 13.7 ± |
| weight (g) | 0.3 | 0.3 | 0.2† | 0.2* | 0.2 | 0.2 |

Values are the mean ± SEM (standard error of the mean).
*Significantly different from the sample from the preferred embodiment apparatus (P < 0.05)
†Significantly different from the sample from the preferred embodiment apparatus (P < 0.05)

Benefits of the Preferred Embodiment

It can be seen from the above experimental results that the preferred embodiment apparatus provides a number of benefits.

Overall, it can be seen that the preferred embodiment apparatus provides a successful alternative mussel storage system. It provides mussels with a moist environment, is simple to use and robust, and does not require a large volume of water. Storing the mussels using the preferred embodiment apparatus also resulted in significant advantages over the commercially used dry storage system. These were: improved shellfish condition, lower whole weight loss, significantly improved meat weight after blanching, improved processability and reduced mortality.

Accordingly, the preferred embodiment system provides improved properties over existing shellfish storage systems, by creating a supportive wet environment while minimising water (or other liquid) consumption by creating a foam environment in the tank. That is particularly advantageous for transport and bulk storage applications.

The water consumption is reduced due to an increase in water residence time, which reduces water turnover, and the shifting of less water mass enables air or other gas to be used to drive the fluid flow in the system. The provision of foam also increases the water/air interface area, which provides for improved gas exchange with the animals. Additionally, the foam expands to cover a higher volume than if the water was just sprayed, and tends to creep into voids to provide good coverage of the aquatic animals.

Consistent Shellfish Condition

One of the major issues facing mussel processing companies is the inconsistent, variable condition that the mussels arrive at the factory when using prior art storage systems. Some mussels are dehydrated (no intravalvular water), others half full, and some full of intravalvular water. With this amount of variability resulting from transport and storage alone it makes it very difficult to design processing systems that will optimise product quality. Storage of mussels in the preferred embodiment apparatus resulted in mussels that could retain their intravalvular water and thus delay dehydration, thereby providing a more consistent and less variable raw material for processing.

Using dry bale methods, a bale can arrive at the bale store with an internal temperature of 18-20° C. during summer. Due to the mass of a bale (750 kg) the interior is slow to cool when transferred to the bale store even though the bale store is regulated to 7° C., which again increases raw material variability.

Consistent shellfish condition is important if live shellfish are to be sold, and also provides improved final properties for factory processed shellfish.

Both the high temperatures on arrival at the bale store and the slow rate of cooling could be improved if some cooling could be achieved during transport. Using the preferred embodiment apparatus, it is possible to cool the mussels during transport by pumping cooled air or gas through the mussels rather than pumping the air or gas at ambient temperature. The amount of cooling can be controlled by adjusting the temperature of the air or gas. The air or gas could be refrigerated or humidified to achieve the desired results.

Reduction in variability of the mussels allows for more efficient process design with regards to cooking temperature and length of cooking time. The down-stream advantage of higher meat weight makes the use of the preferred embodiment apparatus attractive for commercial implementation. This in turn leads to a more consistent product coming out of the blanching process which creates more options for how to shuck and process the meats.

Foam fractionation in the preferred embodiment system can potentially remove or stabilise bacteria to improve safety of the final food product. Further, the system also has the potential of improving safety of the final food product through the addition of antimicrobial agents or similar to the storage tank.

Improved Processability

Significant processability gains were realised from mussels that had been stored in the preferred embodiment apparatus. The occurrence of lip adhesion in mussels stored in the preferred embodiment apparatus was low (average 5%) compared with dry stored mussels (average 17%). Lip adhesion causes a lot of losses in the factory, not only in the down grading of product due to the tearing of the mussel meat, but also in increased shucking time per mussel. To minimise lip adhesion with the current commercial practise of dry mussel storage, mussels need to be blanched at 94° C. In comparison mussels that have been stored in the preferred embodiment system can be blanched as low as 80° C. with minimal incidence of lip adhesion.

Improved Organoleptic Quality

The odour of the mussels after storage in the different regimes also differed. Dry stored mussels smelt musty and unpleasant whereas the mussels stored in the preferred embodiment apparatus smelt fresh and salty (seawater smell).

The difference in odour between the dry mussels and mussels from the preferred embodiment apparatus carries on to the taste of the mussels, with mussels from the preferred embodiment apparatus tasting succulent and fresh as if they had been blanched immediately after being removed from the sea whereas dry stored mussels had developed other, less pleasant flavour characteristics.

With the preferred embodiment apparatus, the improved organoleptic quality can be achieved without requiring auxilliary biofiltration or other water treatment, although they could be used if desired.

Improved Yield

Whole Weight Change

Whole weight loss was minimal in mussels stored in the preferred embodiment apparatus (average of all samples 2.7%). In comparison, mussels stored dry lost significantly more weight over the storage period (average 12.6%).

Meat Weight

In all the experiments storage of mussels in the preferred embodiment apparatus resulted in an increase in blanched meat weight compared with dry stored mussels. The average blanched meat weight of dry stored mussels was ˜12.6 g with preferred embodiment apparatus mussels being ˜13.9 g.

Prevention of Crushing and Shell Breakage

Shell breakage and crushing of mussels can occur in bales when the bales are moved from place to place and stacked on top of one another for transport and during storage in the bale store. The preferred embodiment apparatus would preferably be implemented with a solid container such as a bin, or with a solid housing or tank. This would decrease the amount of shell breakage and damage occurring and therefore allow a greater number of mussels to be processed.

Reduced Mortality Rates

The average mortality rate using the preferred embodiment apparatus was about 27% of the average mortality rate of mussels kept in a dry storage system and about 36% of the average mortality rate of mussels kept in a submerged storage system.

Potential Modifications

Modifications can be made to the preferred embodiment above without departing from the scope of the invention as defined by the claims.

For example, many of the advantages outlined above result primarily from the provision of a foam environment, and other arrangements for creating a foam environment in the interior of the tank could be used rather than the preferred embodiment apparatus which has an air lift as described above. For example, rather than using a system having a bed of fluid which is recirculated through the air lift system to generate the foam, the foam could be provided separately in a storage tank for example, and could be sprayed over the shellfish. In that embodiment, the arrangement for creating a foam environment in the interior of the tank is configured to deliver the foam, such as a synthetic foam. The foam could be drained and replaced with further foam from the storage tank, so that the shellfish are generally held in a foam environment. Such an arrangement would provide many of the same benefits above. However, some of the benefits above (such as the organoleptic benefits) likely result from the air in the air lift of the preferred embodiment apparatus stripping tainting compounds and toxins from the fluid/foam, which would not occur in an embodiment which didn't utilise air or gas to move the fluid/foam. It should be appreciated that all of the advantages outlined above do not apply to all possible embodiments of the present invention, and the stated advantages should not be construed as being limiting.

In some applications, advantages could be achieved by both generating foam (from the animals' natural proteins for example) and by supplementing that with the delivery of a further foam (which could be synthetic or natural) as required.

The actual configuration of the preferred embodiment apparatus described above can be changed without departing from the scope of the present invention. For example, the components which make up the foam generating arrangement 9 are one embodiment only, and other components could be used to make an arrangement which functions in a similar way. For example, hosing components could be used for a smaller foam generating arrangement.

The preferred embodiment apparatus can be readily configured to deliver one or more property-enhancing substances—for example by introducing the substance(s) into the fluid or foam either as part of the recirculation arrangement or separately. That could be achieved by introducing the substance(s) with the air or gas which mixes with the fluid, or could be achieved using a separate inlet. Suitable substances include but are not limited to sanitising agents and antimicrobial agents.

The experimental results outlined above are from tests on mussels; however it should be appreciated that the preferred embodiment apparatus is suitable for storing other shellfish, such as oysters, scallops, clams or abalone. Further, the preferred embodiment apparatus has application for other aquatic animals including, but not limited to, crustaceans and eels.

1.-26. (canceled)

27. An apparatus for storing aquatic animals, comprising
a tank for receipt of a plurality of aquatic animals, said tank having an interior with an upper region, the interior of the tank further having a lower region for receipt of the aquatic animals; and
means for delivering foam comprising one or more foam outlets positioned in the upper region of the tank to deliver foam to the interior of the tank to form a foam environment in the lower region of the interior of the tank, such that at least a majority of the aquatic animals when stored in the lower region of the interior of the tank are submerged in foam.

28. The apparatus as claimed in claim 27 wherein the means for delivering foam comprises:
means for circulating fluid in said tank from the lower region of the tank to the upper region of the tank, the means for circulating fluid comprising said one or more foam outlets positioned in the upper region of the tank; and
means for injecting a gas into said circulating means such that foam is generated in said circulating means.

29. The apparatus as claimed in claim 28 wherein the gas injecting means comprises means for pulsing the gas as the gas is injected into the circulating means whereby the foam can be applied over the aquatic animals in pulses.

30. The apparatus as claimed in claim 27 wherein the means for delivering foam to the interior of the tank comprises:
a fluid conduit extending from the lower region of the interior of the tank to the upper region of the tank, wherein the fluid conduit is in fluid communication with said one or more foam outlets in the upper region of the tank, and
means for introducing a pressurized gas into the fluid conduit so as to generate a vacuum to suck fluid from the lower region of the interior of the tank and deliver fluid to the upper region of the tank via the fluid conduit and through said one or more foam outlets in the upper region of the tank, whereby the fluid can be applied as a foam over at least a majority of the aquatic animals when stored in the lower region of the interior of the tank.

31. The apparatus as claimed in claim 27 wherein the means for delivering foam comprises a source of synthetic foam operatively connected to said one or more foam outlets.

32. The apparatus as claimed in claim 27 wherein said one or more foam outlets are positioned above any liquid in the tank.

33. The apparatus as claimed in claim 32 wherein said one or more foam outlets are positioned above any aquatic animals stored in the tank.

34. The apparatus as claimed in claim 33 wherein the position of said one or more foam outlets is such that the foam moves downwardly around any aquatic animals stored in the tank under the influence of gravity.

35. An apparatus for storing aquatic animals, comprising
a tank for receipt of a plurality of aquatic animals, said tank having an interior with an upper region, the interior of the tank further having a lower region for receipt of the aquatic animals, and
means for recirculating fluid from the lower region of the interior of the tank in which the aquatic animals are stored to the upper region of the interior of the tank and through one or more outlets into the upper region of the interior of the tank, such that the fluid passes over at least a majority of the aquatic animals when stored in the tank and the natural proteins of the aquatic animals create a foam as the fluid is recirculated, whereby at least a majority of the aquatic animals when stored in the tank are submerged in foam.

36. The apparatus as claimed in claim 35 comprising means for injecting a gas into said recirculating means such that foam is generated in said recirculating means.

37. The apparatus as claimed in claim 36 wherein the gas injecting means comprises means for pulsing the gas as the gas is injected into the circulating means whereby the foam can be applied over the aquatic animals in pulses.

38. The apparatus as claimed in claim 35 wherein said one or more outlets are positioned above any liquid in the tank.

39. The apparatus as claimed in claim 38 wherein said one or more outlets are positioned above any aquatic animals stored in the tank.

40. The apparatus as claimed in claim 39 wherein the position of said one or more outlets is such that the foam moves downwardly around any aquatic animals stored in the tank under the influence of gravity.

41. A method of storing aquatic animals, comprising the steps of
providing a tank having an interior;
loading a plurality of aquatic animals into the interior of the tank; and
delivering foam to the interior of the tank in an amount sufficient to submerge at least a majority of the aquatic animals in the tank in the foam.

42. A method as claimed in claim 41 wherein the interior of the tank comprises an upper region, the interior further comprising a lower region for receipt of the aquatic animals, wherein the step of loading a plurality of aquatic animals into the interior of the tank comprises loading the aquatic animals into the lower region of the interior of the tank, and wherein the step of delivering foam comprises delivering the foam through one or more foam outlets that are positioned in the upper region of the tank to form a foam environment in the lower region of the interior of the tank in which the aquatic animals are submerged.

43. A method as claimed in claim 42 wherein the step of delivering foam comprises delivering the foam through said one or more foam outlets above any liquid in the tank.

44. A method as claimed in claim 43 wherein the step of delivering foam comprises delivering the foam through said one or more foam outlets above any aquatic animals stored in the tank.

45. A method as claimed in claim 44 comprising the step of packing the plurality of aquatic animals relatively tightly in the interior of the tank to form a packed bed, so that the foam moves slowly downwardly around the plurality of aquatic animals in the tank under the influence of gravity.

46. A method as claimed in claim 41, wherein the interior of the tank comprises an upper region, the interior further comprising a lower region for receipt of the aquatic animals, wherein the step of loading a plurality of aquatic animals into the interior of the tank comprises loading the aquatic animals into the lower region of the interior of the tank, the method further comprising the steps of
providing a liquid in the base of the lower region of the interior of the tank so as to submerge at least a portion of the plurality of aquatic animals in the lower region of the interior of the tank; and
recirculating the liquid from the lower region of the interior of the tank to the upper region of the interior of the tank through one or more outlets positioned in the upper region of the tank and over at least a majority of the aquatic animals in the lower region of the interior of the tank to generate foam from the natural proteins of the aquatic animals.

47. A method as claimed in claim 46, wherein the step of recirculating liquid results in a decrease in the amount of liquid and an increase in the amount of foam in the interior of the tank over time.

48. A method as claimed in claim 46, comprising the step of mixing pressurized gas with the liquid to enhance foam generation.

49. A method as claimed in claim 46, comprising the step of introducing the pressurized gas in pulses, so that the foam is recirculated into the upper region of the tank and over the aquatic animals in pulses.

50. A method as claimed in claim 49, wherein the step of mixing the pressurized gas comprises mixing pressurized gas that is refrigerated or humidified.

51. A method of storing aquatic animals, comprising the steps of
providing a tank having an interior, wherein the interior of the tank comprises an upper region, the interior further comprising a lower region for receipt of aquatic animals;
loading a plurality of aquatic animals into the lower region of the interior of the tank;
filling at least a portion of the tank with liquid; and then
recirculating the liquid from the lower region of the interior to the upper region of the interior through one or more outlets positioned in the upper region of the interior of the tank and downwardly around at least a majority of the aquatic animals in the lower region of the interior of the tank under the influence of gravity to generate foam from the natural proteins of the aquatic animals in an amount sufficient to submerge at least a majority of the aquatic animals in the tank in the foam.

52. A method as claimed in claim 51, comprising the step of mixing pressurized gas with the liquid to enhance foam generation.

53. A method as claimed in claim 52, comprising the step of introducing the pressurized gas in pulses, so that the foam is recirculated into the upper region of the tank and over the aquatic animals in pulses.

54. A method as claimed in claim 52, wherein the step of mixing the pressurized gas comprises mixing pressurized gas that is refrigerated or humidified.

55. A method as claimed in claim 51, wherein the step of recirculating liquid results in a decrease in the amount of liquid and an increase in the amount of foam in the interior of the tank over time.
